(19) United States
(12) Patent Application Publication
(10) Pub. No.: US 2018/0228128 A1
(43) Pub. Date: Aug. 16, 2018

(54) Pet Feeding Control System

(71) Applicant: Andy H. Gibbs, Tucson, AZ (US)

(72) Inventor: Andy H. Gibbs, Tucson, AZ (US)

(21) Appl. No.: 15/897,608

(22) Filed: Feb. 15, 2018

Related U.S. Application Data
(60) Provisional application No. 62/459,115, filed on Feb. 15, 2017.

(51) Int. Cl. A01K 5/01; A01M 29/16; A01M 29/22; A01M 29/24; A01M 29/30; A01K 15/02; A01K 5/02; A01K 11/00; G05B 15/02

(52) U.S. Cl. CPC A01K 5/0142; A01M 29/16; A01M 29/22; A01M 29/24; A01M 29/30; A01K 13/003; A01K 15/021; A01K 5/0291; A01K 11/006; G05B 15/02; A01K 5/0121

(57) ABSTRACT

A pet feeding control system for ensuring that one or more pets consume the specific food paired to them. The pet feeding control system generally includes a pet identifier device configured to be physically attached to a pet, a bowl that receives a consumable product for the pet, a consumable product identifier device, and a monitor device configured to communicate with the pet identifier device or the consumable product identifier device. The pet identifier device is configured to wirelessly communicate with the consumable product identifier device when the pet identifier device is near the consumable product identifier device with a preventive action initiated if the pet is not authorized to consume the consumable product.

### CROSS REFERENCE TO RELATED APPLICATIONS

I hereby claim benefit under Title 35, United States Code, Section 119(e) of United States provisional patent application Ser. No. 62/459,115 filed Feb. 15, 2017 (Attorney Docket No. GIBB-074). The 62/459,115 application is currently pending. The 62/459,115 application is hereby incorporated by reference into this application.

### STATEMENT REGARDING FEDERALLY SPONSORED RESEARCH OR DEVELOPMENT

Not applicable to this application.

### BACKGROUND

### Field

Example embodiments in general relate to a pet feeding control system for ensuring that one or more pets consume the specific food paired to them.

### Related Art

Any discussion of the related art throughout the specification should in no way be considered as an admission that such related art is widely known or forms part of common general knowledge in the field.

It is well known to those skilled in the art that certain food items are frequently specifically selected to meet the nutritional needs of a pet animal (e.g. cat, dog), and that in many instances, the specific food item is mistakenly consumed by a different animal leading to malnourishment of the intended animal, or that a specific animal can consume the intended food, and additional food that was intended for a different animal, thereby overeating.

There is significant value and efficacy of a system and method of positively correlating the correct food item to be consumed by the intended animal, and a communication system that would further send signals to various devices that would alert humans to take interventional action, and/or send signals to the animal as a means of training the animal to not consume food not intended for their consumption.

### SUMMARY

An example embodiment is directed to a pet feeding control system. The pet feeding control system includes a pet identifier device configured to be physically attached to a pet, a bowl that receives a consumable product for the pet, a consumable product identifier device, and a monitor device configured to communicate with the pet identifier device or the consumable product identifier device. The pet identifier device is configured to wirelessly communicate with the consumable product identifier device when the pet identifier device is near the consumable product identifier device with a preventive action initiated if the pet is not authorized to consume the consumable product.

The various embodiments of the present invention provide a system and method providing for the identification of a plurality of unique food items, identification of a plurality of unique animals, and the positive or dispositive correlation between a food item and an animal prior to food consumption.

The various embodiments of the present invention further provide a means for human intervention between each unique animal and an unintended food item, and a means of training an animal to not consume food items not intended for their consumption.

These and other embodiments will become known to those skilled in the art, especially after recognizing the commercial value attributable to enhanced goodwill through real-time communication with animal owners, and the reduced risks and costs associated with food, supplement and medication recalls.

There has thus been outlined, rather broadly, some of the embodiments of the pet feeding control system in order that the detailed description thereof may be better understood, and in order that the present contribution to the art may be better appreciated. There are additional embodiments of the pet feeding control system that will be described hereinafter and that will form the subject matter of the claims appended hereto. In this respect, before explaining at least one embodiment of the pet feeding control system in detail, it is to be understood that the pet feeding control system is not limited in its application to the details of construction or to the arrangements of the components set forth in the following description or illustrated in the drawings. The pet feeding control system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is an exemplary diagram illustrating a communication system comprising an animal transceiver and electronically identifiable food source in accordance with an example embodiment.

FIG. 2 is an exemplary diagram illustrating a variation of a communication system comprising an animal transceiver and electronically identifiable food source in accordance with an example embodiment.

FIG. 3 is an exemplary diagram illustrating a communication system comprising an animal transceiver and electronically identifiable food location in accordance with an example embodiment.

FIG. 4 is an exemplary diagram illustrating a communication system activated as a result of a dispositive correlation between a unique animal transceiver and a unique electronically identifiable food source in accordance with an example embodiment.

FIG. 5 is an exemplary illustration of a flow chart for correlating an animal to an electronically identifiable food source in accordance with an example embodiment.

FIG. 6 is an exemplary illustration of a flow chart for correlating an animal to an electronically identifiable food location in accordance with an example embodiment.

FIG. 7 is an exemplary illustration of a block diagram of a system providing for authentication of an animal to consume food from an electronically identifiable food source in accordance with an example embodiment.

FIG. 8A is an exemplary diagram illustrating a food bowl with a movable cover to selectively open and close the food bowl to provide or deny access to the food within the food bowl by a pet animal in accordance with an example embodiment.

FIG. 8B is an exemplary diagram illustration the food bowl with a movable cover moved to a closed position to prevent access to the food within the food bowl when the animal is determined not to be authorized to access or consume the food within the food bowl in accordance with an example embodiment.

### DETAILED DESCRIPTION

An example pet feeding control system generally comprises a pet identifier device 100 configured to be physically attached to a pet, a bowl 102 that receives a consumable product for the pet, a consumable product identifier device 101, and a monitor device 103 configured to communicate with the pet identifier device 100 or the consumable product identifier device 101. The pet identifier device 100 is configured to wirelessly communicate with the consumable product identifier device 101 when the pet identifier device 100 is near the consumable product identifier device 101 with a preventive action initiated if the pet is not authorized to consume the consumable product. The preventive action may be initiated by the monitor device 103, the pet identifier device 100 and/or the consumable product identifier device 101. The determination as to whether the patent is authorized to consume the consumable product (e.g. food, medication, liquid, etc.) may be determined by the monitor device 103, the pet identifier device 100, the consumable product identifier device 101 and/or a remote device such as a server 104.

Some of the various embodiments disclosed herein are for the wireless communication at least between a device affixed to an animal and a food item and/or location of a food item. The communication between the objects just described incorporating wireless devices, readers, and tags is well known to those skilled in the art, and comprise a large body of work. It is not the intention to limit the types of wireless devices, readers or tags, the non-limiting description of wireless devices, readers, and tags as follows may be used interchangeably without any difference in meaning or intention.

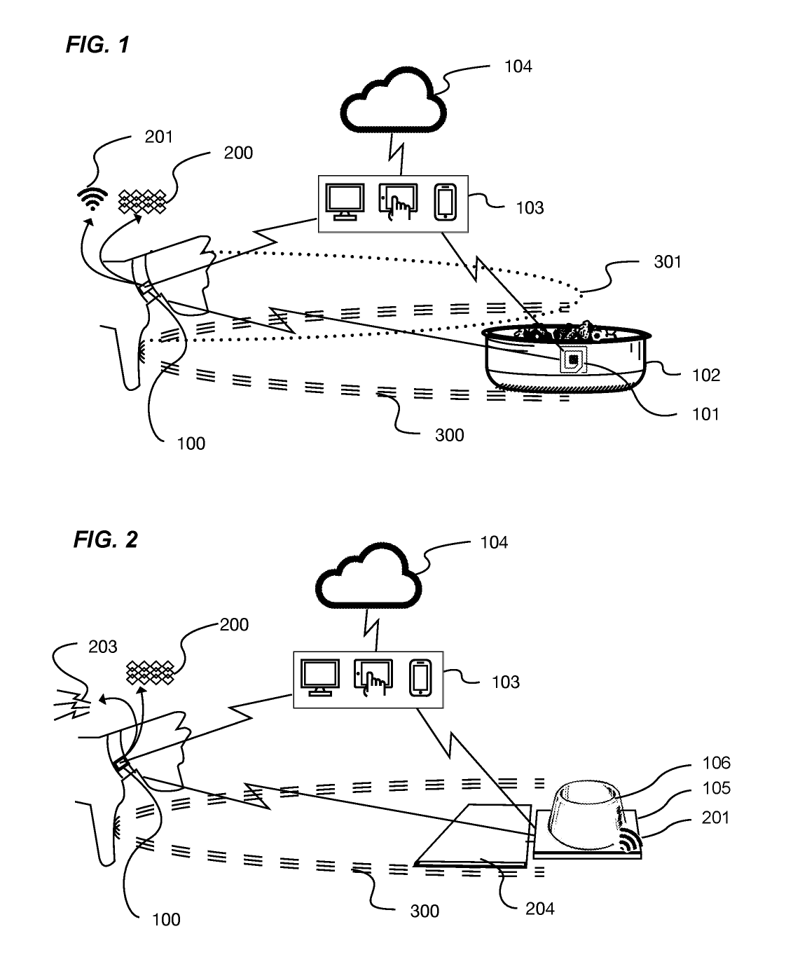

FIG. 1 is an exemplary diagram illustrating a communication system comprising an animal transceiver and electronically identifiable food source. A transceiver 100 is affixed to an animal collar, the transceiver providing for duplex wireless communication with one or more monitor devices 103 on a network. The monitor devices may include electronic devices, mobile electronic devices, smartphones, tablets, computers, routers, and/or any other device configured to receive and/or transmit information over a network.

A food bowl 102 manufactured with an integral or attached tag 101, the tag being any electronics communication chip such as an RFID tag or Near Field Communication (NFC) chip, the tag providing for the storage of data that at least includes a unique identifier, and characteristics associated with food in a food bowl 102, and/or a predefined communication radius, and a means to communicate the characteristics directly or indirectly to a network and/or to a transceiver on an animal.

The tag and the animal transceiver are in at least periodic communication with a device 103 on the network, the device further being in communication with a server and database 104 on the network.

The server and database contain records of a plurality of animal identifications each of which is associated with a unique transceiver, and records of a plurality of food items. Any one or more food items may be associated with one unique animal transceiver.

In practice, when animal with a transceiver 100 enters a predefined perimeter 300 around a tagged 101 food item 102, communication directly and/or indirectly between the tag and animal transceiver activates a server query upon the network, the query causing a microprocessor to analyze the correlation between the transceiver and the food tag. If the animal to which the unique transceiver is affixed correlates positively to the unique identification of the food tag, no further analysis or communication is required, and the animal proceeds to consume the food.

On the other hand, if the animal to which the unique transceiver is affixed correlates dispositively to the unique identification of the food tag, a signal is sent from the server 104 directly or indirectly via a network to the animal transceiver 100 causing the activation of one of more means of alerting the animal of unacceptable behavior, the one or more means being preferably activation of an audio alert 201 and/or a physical vibration 200 of the transceiver, the alert continuing preferably until the animal and transceiver move to a location outside the predefined perimeter 300 about the food tag 101.

Further, in the event of a dispositive determination as just described, the server may also send a signal via a network to one or more devices 103 which also correlate positively to the animal transceiver identification, the sent signal comprising one or more of a text message, an email message, a voice message, or an alert tone, the alert thereby providing time for the recipient of the message to intervene between the animal and the dispositively associated food.

It should be noted that any alert activated on the transceiver as just described may be continuously activated, or intermittently activated while within the prohibited perimeter of the food as a means to conserve battery power.

It should be further noted that one variation to the condition just described, and as will be subsequently described, in which an animal with a transceiver 100 enters a predefined perimeter 300 around a tagged 101 food item 102 may be that a transceiver affixed to an animal has a predetermined communication radius 301, and when the animal move in a direction that causes a food item to become located within the communication radius, communication directly and/or indirectly between the tag and animal transceiver activates a server query upon the network, the query causing a microprocessor to analyze the correlation between the transceiver and the food tag as just described.

FIG. 2 is an exemplary diagram illustrating a variation of a communication system comprising an animal transceiver and electronically identifiable food source. A transceiver 100 is affixed to an animal collar, the transceiver providing for duplex wireless communication with one or more monitor devices 103 on a network. The monitor devices may include electronic devices, mobile electronic devices, smartphones, tablets, computers, routers, and/or any other device configured to receive and/or transmit information over a network.

A food bowl 102 is positioned upon or proximate to a device containing a unique identifier tag 105, the tag being any electronics communication chip such as an RFID tag or Near Field Communication (NFC) chip or transceiver, the tag providing for the storage of data that at least includes a communication perimeter, and a means to communicate directly or indirectly to a network and/or to a transceiver on an animal.

The tag and the animal transceiver are in at least periodic communication with a device 103 on the network, the device further being in communication with a server and database 104 on the network. The server and database contain records of a plurality of animal identifications each of which is associated with a unique transceiver, and records of a plurality of food items. Any one or more food items may be associated with one unique animal transceiver.

In practice, when animal with a transceiver 100 enters a predefined perimeter 300 around a tagged device 105 proximate to which a food bowl 106 containing a unique food item has been placed, communication directly and/or indirectly between the tag and animal transceiver activates a server query upon the network, the query causing a microprocessor to analyze the correlation between the transceiver and the unique food. If the animal to which the unique transceiver is affixed correlates positively to the unique identification of the food tag, no further analysis or communication is required, and the animal proceeds to consume the food.

On the other hand, if the animal to which the unique transceiver is affixed correlates dispositively to the unique identification of the food, a signal is sent from the server 104 directly or indirectly via a network to the animal transceiver 100 causing the activation of one of more means of alerting the animal of unacceptable behavior, the one or more means being preferably being activation of an audio alert 201 and/or a physical vibration 200 of the transceiver as previously described, or alternatively or in combination, an audio alert being provided by the tagged device 105, the alert continuing preferably until the animal and transceiver move to a location outside the predefined perimeter 300 about the food tag 101.

Further, in the event of a dispositive determination as just described, the server may also send a signal via a network to one or more devices 103 which also correlate positively to the animal transceiver identification, the sent signal comprising one or more of a text message, an email message, a voice message, or an alert tone, the alert thereby providing time for the recipient of the message to intervene between the animal and the dispositively associated food.

Those skilled in the art will appreciate that some particularly obstinate or easily distracted animals may require a more assertive approach to behavior modification, that being the minimal necessary current electrification of an object in contact with an animal. IN the drawing, one device is a collar with electrical probes that are activated 203 by a signal sent to the collar device, a practice well known to those who train hunting dogs. Another method is the electrification of a floor mat 204 proximate to the food source, the floor mat electrification being activated via a dispositive signal as previously described. Although electrification of a collar or floor mat may be a animal behavior modification and animal alerting method that may be used whenever an animal alarm is referred to herein, this method should be considered the last resort method of preventing an animal from inappropriately consuming food from an unauthorized food source.

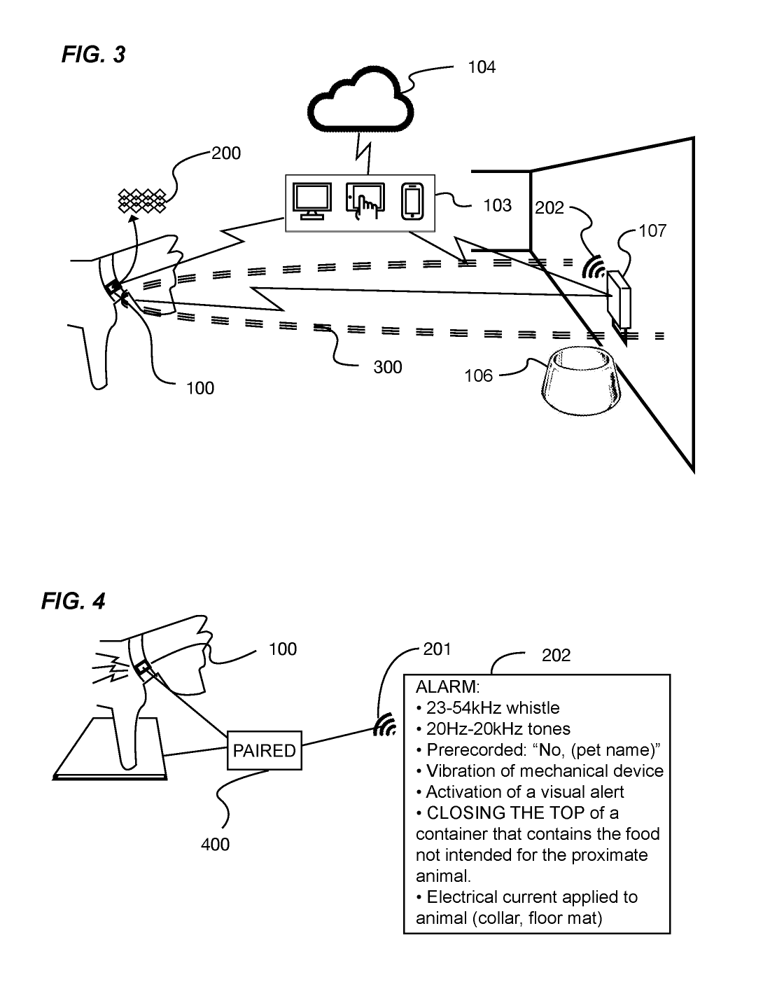

FIG. 3 is an exemplary diagram illustrating a communication system comprising an animal transceiver and an electronically identifiable food location. A transceiver 100 is affixed to an animal collar that provides for duplex wireless communication with one or more monitor devices 103 on a network. The monitor devices 103 may include electronic devices, mobile electronic devices, smartphones, tablets, computers, routers, and/or any other electronic device configured to receive and/or transmit information over a network.

A food bowl 106 is positioned upon or proximate to a device containing a unique identifier tag 107, the tag being any electronics communication chip such as an RFID tag or Near Field Communication (NFC) chip or transceiver, the tag providing for the storage of data that at least includes a communication perimeter, and a means to communicate directly or indirectly to a network and/or to a transceiver on an animal. The tag and the animal transceiver are in at least periodic communication with a device 103 on the network, the device further being in communication with a server and database 104 on the network.

The server and database contain records of a plurality of animal identifications each of which is associated with a unique transceiver, and records of a plurality of food items. Any one or more food items may be associated with one unique animal transceiver.

In practice, when animal with a transceiver 100 enters a predefined perimeter 300 around a tagged food location device 107 proximate to which a food bowl 106 containing a unique food item has been placed, communication directly and/or indirectly between the tag and animal transceiver activates a server query upon the network, the query causing a microprocessor to analyze the correlation between the transceiver and the unique food.

If the animal to which the unique transceiver is affixed correlates dispositively to the unique identification of the food, a signal is sent from the server 104 directly or indirectly via a network to the animal transceiver 100 and/or food location device 107 causing the activation of one of more means of alerting the animal of unacceptable behavior, the one or more means being preferably activation of an audio alert 201 and/or a physical vibration 200 of the transceiver as previously described, or alternatively or in combination, an audio alert being activated at the tagged device 107, the alert continuing preferably until the animal and transceiver move to a location outside the predefined perimeter 300 about the food tag 101.

It should be noted that the types of alerts activated by any device as previously described is not meant to me limiting, and any number of any combination of audio, mechanical or visual alerts may be actuated on any device that receives communication from a server related to dispositive correlation between the unique food item and an animal, the intention being to discourage consumption of the food by an animal that does not correlate positively for the consumption of the unique food.

FIG. 4 is an exemplary diagram illustrating a communication system activated as a result of a dispositive correlation between a unique animal transceiver and a unique electronically identifiable food source. As previously described, a dispositive association between an animal and a food results in a signal being sent to at lease one device on a network.

The drawing shows one or more of a transceiver 100 or a tag 201 that may receive an alert activation signal, the activation occurring on the transceiver device 100, at or proximate to a food bowl or feeding location, or on a remotely located device not shown. Upon receiving an activation signal, one or more of various types of alerts 202 may be activated including but not limited to a “dog whistle” frequency above normal human hearing range, a tone within human hearing range, a synthesized or pre-recorded animal owner voice commanding instructions to the animal, a mechanical vibration, a visual alert such as a blinking light, and/or electrification of an animal collar or a floor mat.

Further, if the food is contained within a feeding device equipped with an operable cover, an alert signal may activate the closure of the cover with a dispositive transceiver is with a range less than the minimum perimeter range around the food container.

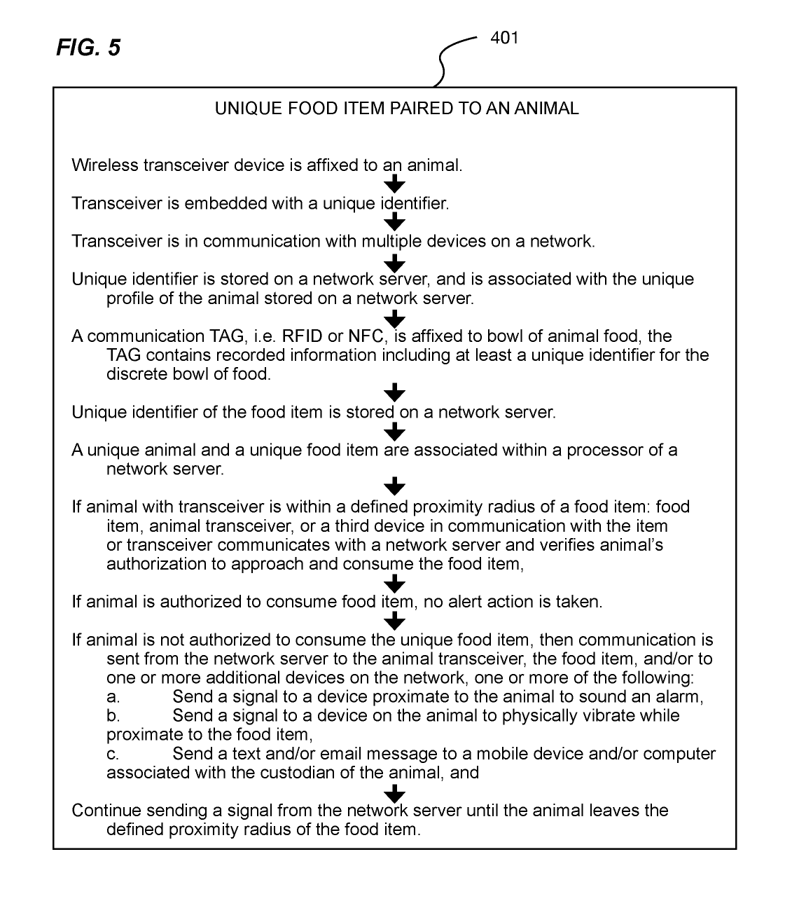

FIG. 5 is an exemplary illustration of a flow chart 401 for correlating an animal to an electronically identifiable food source. The system provides for a wireless transceiver device with a unique identification to be affixed to an animal. It should be noted that a “unique identification” as used herein is not limited to the assignment of a unique code to each transceiver, but may also mean the transceiver on a unique user's network, the association of a commoditized common transceiver associated with a unique user identification having the same effect as a unique transceiver.

The transceiver therefore is in communication with multiple devices on a network which may include a user's mobile phone, home WIFI network, or computer using WIFI, Bluetooth or similar wireless communication means. The unique user and/or transceiver identifier is stored on a network server, and is associated with the unique profile of the animal stored on a network server. A communication TAG, i.e. RFID or NFC, affixed to bowl of animal food contains information related to characteristics associated with that particular an electronically identifiable bowl of food.

Those skilled in the art will appreciate that many household dogs and cats eat a veterinarian-prescribed diet, the prescription providing interventional attributes or pharmaceutical compounds intended to mitigate certain maladies such as diabetes, hypothyroidism, and other common ailments. It is also well regarded by those skilled in the art that normal healthy animals should not consume food products intended to treat medical issues that they are not afflicted with because such consumption could cause disease, sickness or threaten the life of otherwise healthy animals.

Therefore, the unique identifier of the food item is stored on a network server and is associated with a unique animal. If animal with transceiver is within a defined proximity radius of a food item, the transceiver, food tag or a proxy thereof communicates with a network server and verifies animal's authorization to approach and consume the food item. If animal is authorized to consume food item, no alert action is taken. If animal is not authorized to consume the unique food item, then communication is sent from the network server to the animal transceiver, the food item, and/or to one or more additional devices on the network, activating an alert as previously described. The alert signal continues until the animal leaves the defined proximity radius of the food item.

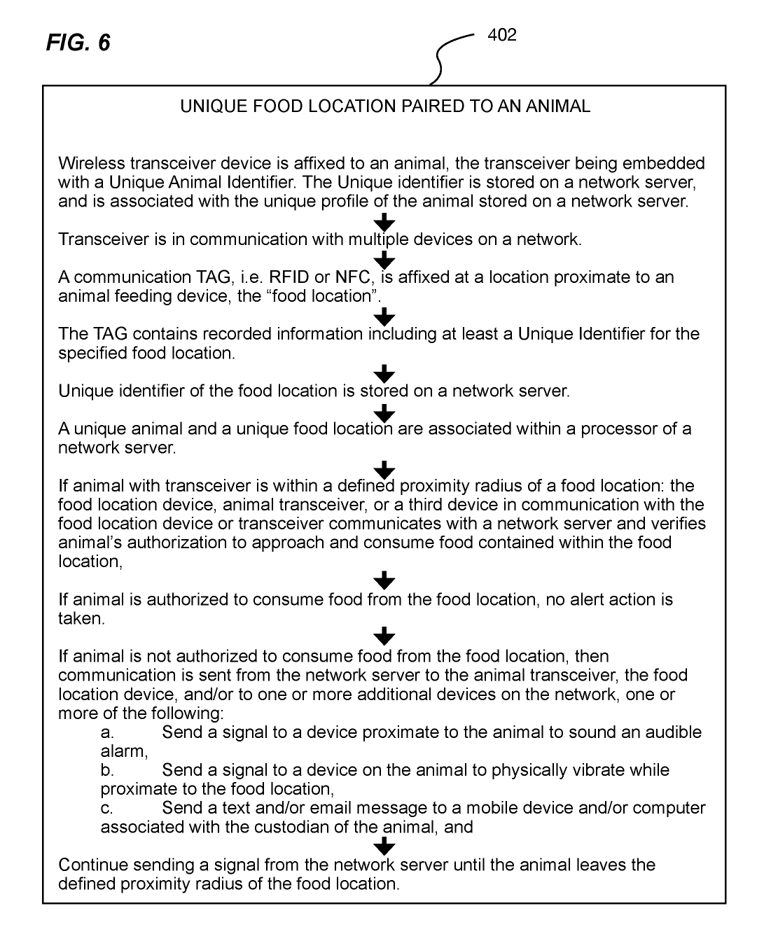

FIG. 6 is an exemplary illustration of a flow chart 402 for correlating an animal to an electronically identifiable food location. The system provides for a wireless transceiver device with a unique identification to be affixed to an animal.

The transceiver is in direct or indirect communication with multiple devices on a network as previously described. The unique user and/or transceiver identifier is stored on a network server, and is associated with the unique profile of the animal stored on a network server. A communication TAG, i.e. RFID or NFC, affixed in a location proximate to a bowl of animal food, the tag containing information related to unique food characteristics.

The unique identifier of the food item is stored on a network server and is associated with a unique animal. If animal with transceiver is within a defined proximity radius of a food item, the transceiver, food tag or a proxy thereof communicates with a network server and determines the animal's authorization to approach and consume the food item. If animal is authorized to consume food item, no alert action is taken. If animal is not authorized to consume the unique food item, then communication is sent from the network server to the animal transceiver, the food item, and/or to one or more additional devices on the network, activating an alert as previously described. The alert signal continues until the animal leaves the defined proximity radius of the food item.

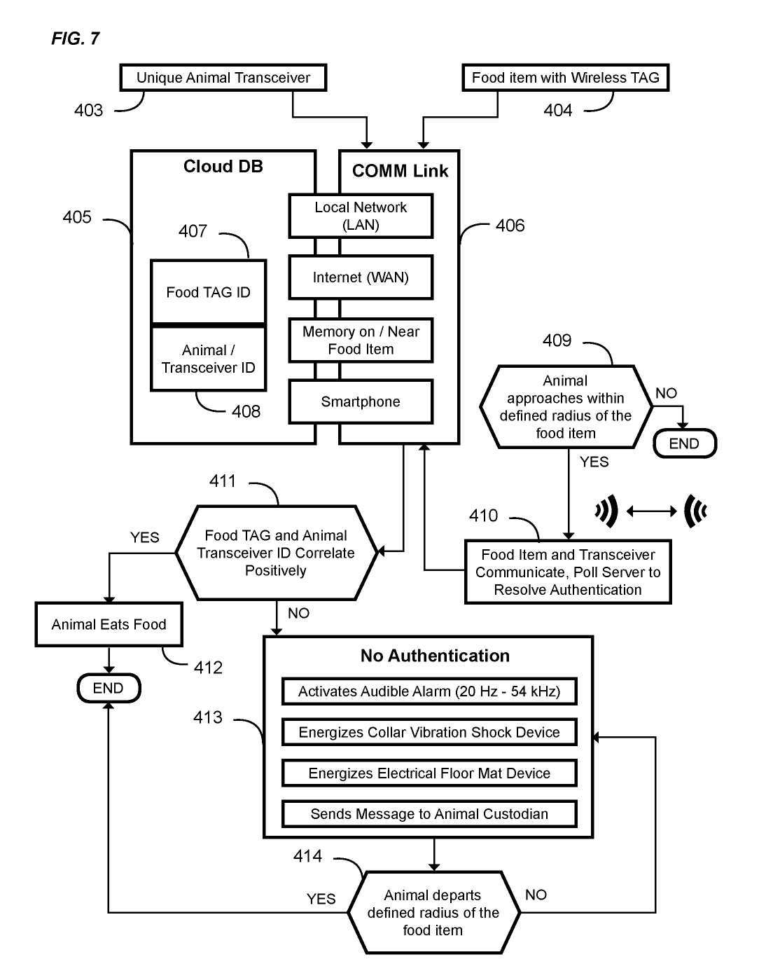

FIG. 7 is an exemplary illustration of a block diagram of a system providing for authentication of an animal to consume food from an electronically identifiable food source. A transceiver 403 is affixed to an animal, the uniqueness of the transceiver being one of a uniquely addressable identification code of the transceiver, or a method of uniquely identifying the user network upon which the transceiver is in communication. A food item 404 is associated with a unique food profile contained in the memory of a tag, or downloadable to a device in communication with the tag upon a network. The tag and transceiver are in direct or indirect communication with a server and database 405 via one or more communication links 406 in communication with a user network. The server and database 405 contains the records of at least one unique animal 408, and one uniquely identifiable animal food 407.

In a typical house environment, an animal may approach food that has been placed in a food bowl on the floor 409. When the transceiver is within a specified range of the food, the distance established as previously described, at least one device on the in-home network 410 communicates directly or indirectly with a server and database 405, sending a query to request a signal to positively or dispositively correlate the animal to the food 411.

If there is a positive correlation, the animal is permitted to eat the food 412. On the other hand, if the query results in a dispositive correlation 413, one or more alerts are activated as previously described, with the intention of driving the animal away from the food to a distance that exceeds the alert perimeter 414 with deactivates the alert signal.

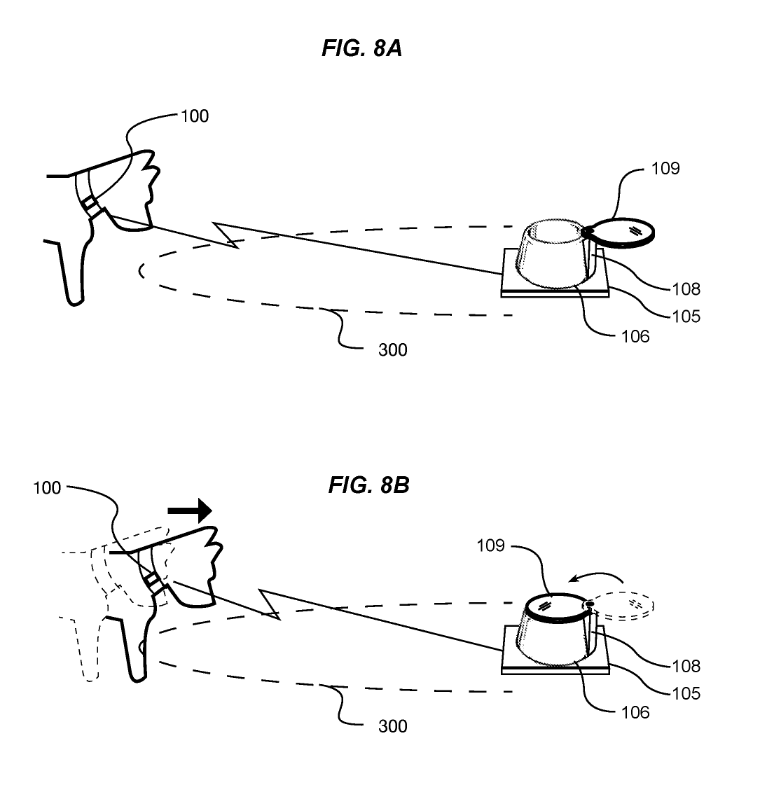

FIGS. 8A and 8B illustrate an actuator 108 affixed to a bowl 106, the actuator 108 closing a cover 109 when a transponder 100 on an animal enters a prescribed location 300 proximate to the food it is not authorized to consume. FIGS. 8A and 8B illustrate a food bowl with a movable cover 109 to selectively open and close the upper opening of the food bowl 106 to provide or deny access to the food or other consumable product within the food bowl 106 by a pet animal in accordance with an example embodiment.

FIG. 8A illustrates the movable cover in the open position to allow access to the consumable product in the food bowl 106. FIG. 8B illustrates the movable cover moved to a closed position to prevent access to the food within the food bowl when the animal is determined not to be authorized to access or consume the food within the food bowl in accordance with an example embodiment.

The movable cover 109 may move in various other manners to selectively open and close the bowl 106 such as, but not limited to, sliding, rotating and pivoting. The movable cover 109 may pivot along a horizontal axis, a vertical axis or otherwise angled axis to selectively close and open the food bowl 106. The movable cover 109 is sufficient in size and shape to substantially cover the upper opening of the food bowl 106 to prevent access to the consumable product (e.g. food, medication) in the food bowl. For example, the movable cover 109 may have a circular shape and size that corresponds to a bowl that has a circular shaped upper opening as illustrated in FIGS. 8A and 8B of the drawings. Various other shapes for food bowls 106 may be used with the various embodiments disclosed (e.g. square, rectangular, oval, triangular, polygonal, etc.) so the cover 109 may be comprised of various other shapes. Furthermore, the cover 109 does not need to be a shape that corresponds to the shape of the bowl 106 (e.g. the bowl 106 may be square shaped and the cover 109 may be oval shaped).

The actuator 108 may be comprised of various types of actuators such as, but not limited to, linear actuators, rotating actuators and the like. The actuator 108 may be motorized and electrically powered via batteries or a power outlet. FIGS. 8A and 8B illustrate an actuator that rotates the movable cover 109 from an open position (FIG. 8A) to a closed position (FIG. 8B).

FIGS. 1 through 4, 8A and 8B illustrate a pet identifier device 100 configured to be physically attached to an animal (e.g. cat, dog, horse, cow, sheep, etc.). It should be understood that the terms “pet” and “animal” are used interchangeably throughout. The pet identifier device 100 stores pet data corresponding to the pet such as, but not limited to, a unique identifier for the pet, name of the pet, age of the pet, food and/or medication the pet is authorized to consume. The pet identifier device 100 is configured to wirelessly communicate with the consumable product identifier device 101 when the pet identifier device 100 is near the consumable product identifier device 101.

The bowl 102, 106 is configured to receive and dispense a volume of a consumable product for the pet. The bowl may have various structures, shapes and sizes capable of receiving a volume of consumable product (e.g. food, medication and/or liquids). The bowl may be comprised of a disposable bowl that is shipped by a manufacturer prefilled with the consumable product or the bowl may be comprised of a traditional pet feeding dish that may be reused by filling with the consumable product.

FIGS. 1 through 3 illustrate a consumable product identifier device 101. The consumable product identifier device 101 stores product data corresponding to the consumable product within the bowl 102, 106 such as, but not limited to, a unique identifier for the consumable product, name of the consumable product, the date of production for the consumable product and/or the identity of one or more animals authorized to consume the consumable product.

The consumable product identifier device 101 is preferably attached to the bowl 102, 106 but may be positioned near the bowl 102, 106 in a non-attached manner. The consumable product identifier device may be comprised of an RFID tag or NFC tag or other electronic devices. The consumable product identifier device may communicate with the monitor device wireless or via a wired connection. The consumable product identifier and/or the pet identifier device may also communicate with a server 104 through a network.

FIGS. 1 through 3 illustrate a monitor device 103. The monitor device 103 is configured to communicate with the pet identifier device 100 or the consumable product identifier device 101. The monitor device 103 is configured to receive the product data and the pet data from the pet identifier device 100 and/or the consumable product identifier device 101. The monitor device 103 is further configured to determine if the consumable product is acceptable for consumption by the pet based on the product data being compared to the pet data. The monitor device 103 is further preferably configured to execute a preventive action if the pet is not authorized to consume the consumable product. In one embodiment, the monitor device 103 is configured to communicate with a server via a global computer network to determine if the pet is authorized to consume the consumable product. The monitor device 103 may be configured to communicate with both the pet identifier device 100 and the consumable product identifier device 101. The monitor device 103 may also be configured to receive the product data from the consumable product identifier device 101 and the pet data from the pet identifier device 100.

The preventive action may be initiated by the monitor device 103, the consumable product identifier device 101 and/or the pet identifier device 100. The preventive action may be comprised of various actions that deter or prevent the pet from accessing and/or consuming the consumable product within the bowl 102, 106. The preventive action may also be an alert to a human user so the user may intervene to prevent access to the consumable product by the animal. For example, the preventative action may be comprised of an audible alert by the monitor device 103, an audible deterrent by the pet identifier device 100, vibration by the pet identifier device 100, an audible deterrent by the consumable product identifier device 101 and the like. As a further example, an electronic pet training mat may be positioned in front of the bowl 106 as shown in FIG. 2 and the preventive action is comprised of electrification of the electronic mat to physically deter the pet from coming near the bowl 102, 106 with the consumable food product.

In another embodiment, the bowl 106 includes a movable cover 109 and an actuator 108 connected to the movable cover as shown in FIGS. 8A and 8B. When the movable cover is in a closed position the movable cover prevents access to the consumable product by the pet as shown in FIG. 8B. When the movable cover is in the open position the pet has access to the consumable product as shown in FIG. 8A. In one embodiment, the movable cover substantially covers an upper opening of the bowl 106 when in the closed position. The movable cover preferably has a shape and size approximately the same as the upper opening of the bowl 106 as shown in FIGS. 8A and 8B. In the embodiment illustrated in FIGS. 8A and 8B, the preventive action is comprised of activating the actuator to move the movable cover into the closed position thereby preventing access to the consumable product by the pet. In the embodiment shown in FIGS. 8A and 8B, the actuator may be comprised of various types of actuators including, but not limited to, linear actuators, electric motors, and rotating electric motor.

Unless otherwise defined, all technical and scientific terms used herein have the same meaning as commonly understood by one of ordinary skill in the art to which this invention belongs. Although methods and materials similar to or equivalent to those described herein can be used in the practice or testing of the pet feeding control system, suitable methods and materials are described above. All publications, patent applications, patents, and other references mentioned herein are incorporated by reference in their entirety to the extent allowed by applicable law and regulations. The pet feeding control system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A pet feeding control system, comprising:
a pet identifier device configured to be physically attached to a pet, wherein the pet identifier device stores pet data corresponding to the pet;
a bowl configured to receive and dispense a volume of a consumable product for the pet;
a consumable product identifier device, wherein the consumable product identifier device stores product data corresponding to the consumable product within the bowl; and
a monitor device configured to communicate with the pet identifier device or the consumable product identifier device;
wherein the pet identifier device is configured to wirelessly communicate with the consumable product identifier device when the pet identifier device is near the consumable product identifier device;
wherein the monitor device is configured to receive the product data and the pet data from the pet identifier device or the consumable product identifier device;
wherein the monitor device is configured to determine if the consumable product is acceptable for consumption by the pet based on the product data being compared to the pet data;
wherein the monitor device is configured to execute a preventive action if the pet is not authorized to consume the consumable product.

2. The pet feeding control system of claim 1, wherein the consumable product identifier device is attached to the bowl.

3. The pet feeding control system of claim 1, wherein the consumable product identifier device is comprised of an RFID tag or NFC tag.

4. The pet feeding control system of claim 1, wherein the monitor device is comprised of a mobile electronic device.

5. The pet feeding control system of claim 1, wherein the monitor device is configured to communicate with a server via a global computer network to determine if the pet is authorized to consume the consumable product.

6. The pet feeding control system of claim 1, wherein the consumable product is comprised of food or medicine potentially consumable by the pet.

7. The pet feeding control system of claim 1, wherein the preventive action is comprised of an audible alert by the monitor device.

8. The pet feeding control system of claim 1, wherein the preventive action is comprised of an audible deterrent by the pet identifier device.

9. The pet feeding control system of claim 1, wherein the preventive action is comprised of vibration by the pet identifier device.

10. The pet feeding control system of claim 1, wherein the preventive action is comprised of an audible deterrent by the consumable product identifier device.

11. The pet feeding control system of claim 1, including an electronic pet training mat positioned in front of the bowl, wherein the preventive action is comprised of electrification of the electronic mat.

12. The pet feeding control system of claim 1, wherein the bowl includes a movable cover and an actuator connected to the movable cover, wherein when the movable cover is in a closed position the movable cover prevents access to the consumable product by the pet, and wherein when the movable cover is in the open position the pet has access to the consumable product.

13. The pet feeding control system of claim 12, wherein the movable cover substantially covers an upper opening of the bowl when in the closed position.

14. The pet feeding control system of claim 13, wherein the movable cover has a shape and size approximately the same as the upper opening of the bowl.

15. The pet feeding control system of claim 12, wherein the preventive action is comprised of activating the actuator to move the movable cover into the closed position.

16. The pet feeding control system of claim 15, wherein the actuator is comprised of a rotating electric motor.

17. The pet feeding control system of claim 1, wherein the bowl is comprised of a disposable bowl.

18. The pet feeding control system of claim 1, wherein the bowl is prefilled with the consumable product.

19. The pet feeding control system of claim 1, wherein the monitor device is configured to communicate with both the pet identifier device and the consumable product identifier device.

20. The pet feeding control system of claim 19, wherein the monitor device is configured to receive the product data from the consumable product identifier device and the pet data from the pet identifier device.
